(19) United States
(12) Patent Application Publication
(10) Pub. No.: US 2020/0250968 A1
(43) Pub. Date: Aug. 6, 2020

(54) TRAFFIC CONGESTION ESTIMATION

(71) Applicant: INTERNATIONAL BUSINESS MACHINES CORPORATION, Armonk, NY (US)

(72) Inventors: Gaku Yamamoto, Machida (JP); Hideyuki Mizuta, Tokyo (JP); Shoichiro Watanabe, Tokyo (JP)

(21) Appl. No.: 16/263,443

(22) Filed: Jan. 31, 2019

(51) Int. Cl. G08G 1/01; G08G 1/052

(52) U.S. Cl. CPC G08G 1/0133; G08G 1/052; G08G 1/0112

(57) ABSTRACT

A computer-implemented method for acquiring a velocity of a vehicle, detecting whether the velocity is in a fluctuating state, and determining that the vehicle is in traffic congestion, in response to a parameter of the velocity being less than or equal to a predetermined threshold value and the velocity being detected to be in the fluctuating state. The computer-implemented method may further be capable of acquiring a position of the vehicle and identifying a position of a tail end of the traffic congestion, based on the position of the vehicle determined to be in the traffic congestion. In exemplary embodiments, if a ratio of vehicles capable of acquiring information is low, then the accuracy of an estimation of traffic congestion also becomes low.

### BACKGROUND

The present invention generally relates to estimating traffic congestion.

Conventionally, various methods have been proposed for estimating a traffic congestion position by acquiring information from vehicles. For example, methods such as “ . . . receiving probe data from mobile probes; deriving, from the received probe data, an approximate . . . traffic congestion area” are recorded in the prior art. However, in a case where the ratio of vehicles from which information can be acquired is low, the accuracy of the estimation also becomes low.

### SUMMARY

According to one embodiment of the present invention, a computer-implemented method comprises: acquiring a velocity of a vehicle; detecting whether the velocity is in a fluctuating state; and determining that the vehicle is in traffic congestion, in response to a parameter of the velocity being less than or equal to a predetermined threshold value and the velocity being detected to be in the fluctuating state. In this way, it is possible to accurately identify the position of traffic congestion.

The computer-implemented method may further comprise: acquiring a position of the vehicle; and identifying a position of a tail end of the traffic congestion, based on the position of the vehicle determined to be a vehicle in the traffic congestion. In this way, it is possible to accurately identify the position of the tail end of the traffic congestion.

According to another embodiment of the present invention, a computer-implemented method is provided, comprising: acquiring a position of a tail end of a traffic congestion, occurring a reference time earlier; estimating a forward progress amount of the tail end of the traffic congestion caused by vehicles in the traffic congestion progressing; estimating a backup amount of the tail end of the traffic congestion caused by vehicles being added to the traffic congestion; and estimating the position of the tail end of the traffic congestion at a current time point, based on the position of the tail end of the traffic congestion occurring the reference time earlier, the forward progress amount, and the backup amount. In this way, it is possible to accurately identify the position of the tail end of the traffic congestion.

The computer-implemented method may further comprise: acquiring the position of the tail end of the traffic congestion at the current time point; and determining whether a distance between the position of the tail end of the traffic congestion, occurring the reference time earlier, and the acquired position of the tail end of the traffic congestion at the current time point is less than a reference distance, wherein the estimating the position of the tail end of the traffic congestion at the current time point is performed in response to the distance being less than the reference distance. In this way, if there is a possibility of erroneously determining that a vehicle is stuck in a traffic congestion due to the ratio of available vehicles being low, it is possible to estimate the position of the tail end of the traffic congestion.

According to yet another embodiment of the present invention, a computer program product including one or more computer readable storage mediums collectively storing program instructions that are executable by a processor or programmable circuitry to cause the processor or the programmable circuitry to perform operations comprising: acquiring a velocity of a vehicle; detecting whether the velocity is in a fluctuating state; and determining that the vehicle is in a traffic congestion, in response to a parameter of the velocity being less than or equal to a predetermined threshold value and the velocity being detected to be in the fluctuating state. In this way, it is possible to accurately identify the position of a traffic congestion.

The operations may further comprise: acquiring a position of the vehicle; and identifying a position of a tail end of the traffic congestion, based on the position of the vehicle determined to be in the traffic congestion. In this way, it is possible to accurately identify the position of the tail end of the traffic congestion.

According to yet another embodiment of the present invention, a computer program product including one or more computer readable storage mediums collectively storing program instructions that are executable by a processor or programmable circuitry to cause the processor or the programmable circuitry to perform operations is provided, comprising: acquiring a position, occurring a reference time earlier, of a tail end of a traffic congestion; estimating a forward progress amount of the tail end of the traffic congestion caused by vehicles in the traffic congestion progressing; estimating a backup amount of the tail end of the traffic congestion caused by vehicles being added to the traffic congestion; and estimating the position of the tail end of the traffic congestion at a current time point, based on the position of the tail end of the traffic congestion occurring the reference time earlier, the forward progress amount, and the backup amount. In this way, it is possible to accurately identify the position of the tail end of the traffic congestion.

The operations may further comprise: acquiring the position of the tail end of the traffic congestion at the current time point; and determining whether a distance between the position of the tail end of the traffic congestion occurring the reference time earlier, and the acquired position of the tail end of the traffic congestion at the current time point is less than a reference distance, wherein the estimating the position of the tail end of the traffic congestion at the current time point is performed in response to the distance being less than the reference distance. In this way, if there is a possibility of erroneously determining that a vehicle is stuck in a traffic congestion due to the ratio of available vehicles being low, it is possible to estimate the position of the tail end of the traffic congestion.

According to yet another embodiment of the present invention is an apparatus comprising: a processor or programmable circuitry; and one or more computer readable mediums collectively including instructions that, in response to being executed by the processor or the programmable circuitry, cause the processor or the programmable circuitry to: acquire a velocity of a vehicle; detect whether the velocity is in a fluctuating state; and determine that the vehicle is in a traffic congestion, in response to a parameter of the velocity being less than or equal to a predetermined threshold value and the velocity being detected to be in the fluctuating state. In this way, it is possible to accurately identify the position of a traffic congestion.

The instructions further causing the processor or programmable circuitry to: acquire a position of the vehicle; and identify a position of a tail end of the traffic congestion, based on the position of the vehicle determined to be in the traffic congestion. In this way, it is possible to accurately identify the position of the tail end of the traffic congestion.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

Embodiments of the present invention will now be described, by way of example only, with reference to the following drawings in which:

FIG. 1 depicts apparatus 1, according to an embodiment of the present invention;

FIG. 2 depicts a state in which apparatus 1 is arranged, according to an embodiment of the present invention;

FIG. 3 depicts the operation of vehicle agent 101, according to an embodiment of the present invention;

FIG. 4 depicts the operation of road agent 102, according to an embodiment of the present invention;

FIG. 5 depicts a specific example of the fluctuating state of the velocity, according to an embodiment of the present invention;

FIG. 6 depicts a transition of positions of vehicles 10 moving onto a road, according to an embodiment of the present invention; and

FIG. 7 depicts an exemplary hardware configuration of a computer, according to an embodiment of the present invention.

### DETAILED DESCRIPTION

Hereinafter, embodiment(s) of the present invention will be described. The embodiment(s) do(es) not limit the invention according to the claims, and all the combinations of the features described in the embodiment(s) are not necessarily essential to means provided by aspects of the invention.

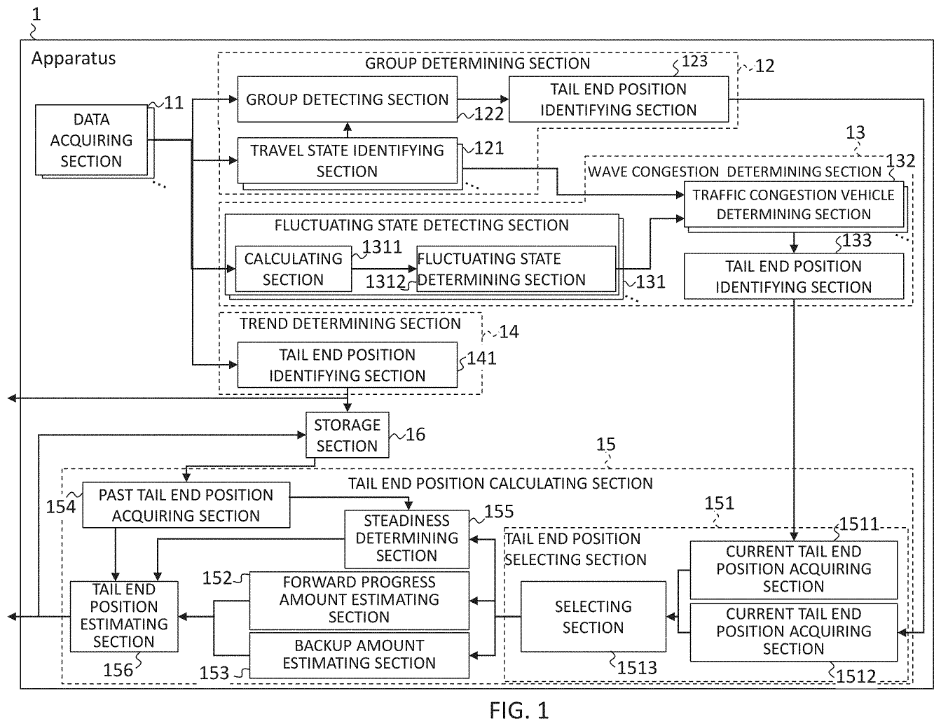

FIG. 1 depicts apparatus 1, according to an embodiment of the present embodiment. The apparatus 1 manages at least one road on which vehicles 10 move. The vehicles 10 may be manned/unmanned automobiles, motorbikes, bicycles, or the like. Some of the vehicles 10 (e.g., 5% of all of the vehicles 10) may each be an Internet of Things (IoT) vehicle 10A including an IoT device. An IoT vehicle 10A may transmit probe car data at designated time intervals. The probe car data may include information detected by the IoT vehicle 10A, such as position information (e.g., longitude and latitude) of the vehicle 10. The apparatus 1 includes one or more data acquiring sections 11, a group determining section 12, a WAVE CONGESTION determining section 13, a trend determining section 14, a tail end position calculating section 15, and a storage section 16.

The one or more data acquiring sections 11 consecutively acquire probe car data (position information) of an IoT vehicle 10A, as an example in the present embodiment. As an example, in the present embodiment, a data acquiring section 11 is provided for each IoT vehicle 10A, and acquires the probe car data from the target IoT vehicle 10A. The data acquiring section 11 may calculate the velocity of this IoT vehicle 10A from the position information of the IoT vehicle 10A included in the probe car data. For example, the data acquiring section 11 may calculate a current velocity V(t) of the IoT vehicle 10A and an average velocity (e.g., a moving average velocity or decaying average velocity) Vₐᵥₑ(t) of the IoT vehicle 10A. Furthermore, the data acquiring section 11 may calculate a velocity trend T(t) indicating a velocity fluctuation trend. The velocity trend T(t) may be expressed as T(t)=(V(t)−V(t−w))/w, using a velocity V(t−w) at a time point w seconds (e.g., 9 seconds) before the current time point. The data acquiring section 11 may supply the acquired position information and velocity information to the group determining section 12, the WAVE CONGESTION determining section 13, and the trend determining section 14.

The group determining section 12 detects a group of vehicles 10 causing traffic congestion (also referred to as a congestion group) and detects a position Pₜ of the tail end of the traffic congestion. The group determining section 12 includes one or more travel state identifying sections 121, a group detecting section 122, and a tail end position identifying section 123.

The one or more travel state identifying sections 121 identify the travel state of each IoT vehicle 10A, based on a velocity parameter of the IoT vehicle 10A. As an example in the present embodiment, a travel state identifying section 121 is provided for each IoT vehicle 10A, and identifies the travel state of the target IoT vehicle 10A based on the velocity parameter of this IoT vehicle 10A. The velocity parameter may be the average velocity Vₐᵥₑ(t), and may be the moving average velocity or the decaying average velocity, for example. The travel state identified by the travel state identifying section 121 may be any one of STOP, CONGESTION, SLOW, and FREE, in a descending order of the travelling velocity Vₐᵥₑ(t). Here, an IoT vehicle 10A whose travel state is CONGESTION or STOP may be traffic congestion vehicle that is positioned in traffic congestion. The travel state identifying section 121 may supply the identified travel state to the group detecting section 122 and the WAVE CONGESTION determining section 13.

The group detecting section 122 detects a congestion group on the road. The group detecting section 122 may calculate the distance between IoT vehicles 10A, based on the position information of each IoT vehicle 10A obtained from the data acquiring section 11. As an example, the group detecting section 122 detects at least one group including vehicles (e.g., IoT vehicles 10A whose travel states are STOP or CONGESTION) in traffic congestion including more than a reference number (e.g., 2) of vehicles in which the distance between vehicles is less than a first reference distance (e.g., 100 m) as a congestion group. The group detecting section 122 may supply the position information of the IoT vehicle 10A at the tail end of each congestion group to the tail end position identifying section 123.

The tail end position identifying section 123 identifies the position of the tail end of the traffic congestion based on the position of the IoT vehicle 10A at the tail end of each congestion group. There are cases where, if the ratio of IoT vehicles 10A to vehicles 10 is low, the accuracy of the tail end position identified by the group determining section 12 is also low. Accordingly, the tail end position identified by the group determining section 12 may be an estimation tail end position Pₜ′ used to estimate the tail end position with higher accuracy. The tail end position identifying section 123 may supply the tail end position Pₜ′ to the tail end position calculating section 15.

The WAVE CONGESTION determining section 13 detects the position Pₜ of the tail end of the traffic congestion by detecting that the vehicle velocity is a low velocity and in a fluctuating state (also referred to as the travel state being a WAVE CONGESTION state). The WAVE CONGESTION determining section 13 includes one or more fluctuating state detecting sections 131, one or more traffic congestion vehicle determining sections 132, and a tail end position identifying section 133.

The one or more fluctuating state detecting sections 131 detect the fluctuating state of the vehicle velocity. As an example in the present embodiment, a fluctuating state detecting section 131 is provided for each IoT vehicle 10A and detects the fluctuating state of the velocity of the target IoT vehicle 10A. Here, fluctuation of the velocity means that the velocity V(t) moves up and down during a default period (e.g., any one of a period of 5 or 10 second to a period of 100 seconds). The fluctuating state detecting section 131 includes a calculating section 1311 and a fluctuating state determining section 1312.

The calculating section 1311 calculates the moving average (also referred to as the wave trend) of the difference a(t) (=V(t)−V(t−i)) between a velocity V(t−i) (where i is a positive natural number) acquired in the past and a newly acquired velocity V(t), and also calculates an index value (also referred to as wave dispersion) indicating the dispersion of the difference a(t). The velocity V(t−i) may be the velocity V(t−1) that is 1 second before the time point t, and the wave trend and wave dispersion values may respectively be the moving average and the dispersion index value of the difference a(t) in a time window having length of the default period. The wave dispersion is an average absolute error and the moving average of the absolute value of the difference a(t) in the present embodiment, but may instead be the distribution of the difference a(t). The calculating section 1311 may supply the calculated wave trend and wave dispersion to the fluctuating state determining section 1312.

The fluctuating state determining section 1312 determines that the velocity is in a fluctuating state, in response to the wave trend being within a first range and the wave dispersion being within a second range. The first range may be a range including zero, and may be a range expressed as −k to k (where k is a positive value), for example. The second range may be a range of positive values, and a lower limit of the second range may be greater than k, for example. The fluctuating state determining section 1312 may supply the determination result to the traffic congestion vehicle determining section 132.

The one or more traffic congestion vehicle determining sections 132 determine an IoT vehicle 10A to be a vehicle in traffic congestion, in response to the velocity parameter (e.g., the current velocity V(t) or average velocity Vₐᵥₑ(t)) of the IoT vehicle 10A being less than or equal to a predetermined first threshold value and the velocity of the IoT vehicle 10A being detected to be in a fluctuating state. Furthermore, in this case, the traffic congestion vehicle determining section 132 may identify the travel state of the IoT vehicle 10A to be the WAVE CONGESTION state. As an example in the present embodiment, a traffic congestion vehicle determining section 132 is provided for each IoT vehicle 10A and determines whether the target IoT vehicle 10A is a vehicle in traffic congestion. The first threshold value may be, for example, 5 km/h. The traffic congestion vehicle determining section 132 may supply the position information of each vehicle in traffic congestion to the tail end position identifying section 133.

The tail end position identifying section 133 identifies the position of the tail end of the traffic congestion, based on the positions of the vehicles 10 determined to be vehicles in the traffic congestion. There are cases where, if the ratio of IoT vehicles 10A to total vehicles 10 is low, the accuracy of the tail end position identified by the WAVE CONGESTION determining section 13 is also low. Accordingly, the tail end position identified by the WAVE CONGESTION determining section 13 may be the estimation tail end position Pₜ′ used to estimate the tail end position with higher accuracy. The tail end position identifying section 133 supplies the tail end position Pₜ′ to the tail end position calculating section 15.

The trend determining section 14 detects the position Pₜ of the tail end of the traffic congestion, based on the velocity trend T(t) (T(t)=(V(t)−V(t−w))/w), as an example in the present embodiment). The trend determining section 14 includes a tail end position identifying section 141.

The tail end position identifying section 141 identifies an IoT vehicle 10A as being the vehicle at the tail end of the traffic congestion, in response to the velocity trend T(t) being less than a reference velocity trend Tref and the velocity of this IoT vehicle 10A being less than a predetermined second threshold value, and identifies the position of this IoT vehicle 10A as the position Pₜ of the tail end of the traffic congestion. The reference velocity trend Tref may be a negative value. The second threshold value may be different from the first threshold value, but is the same as the first threshold value as an example in the present embodiment. The tail end position identifying section 141 may store the tail end position Pₜ in the storage section 16. Furthermore, the tail end position identifying section 141 may output the tail end position Pₜ to the outside of the apparatus 1.

If the position Pₜ of the tail end of the traffic congestion is not identified by the trend determining section 14, the tail end position calculating section 15 calculates the current tail end position based on a past tail end position. The tail end position calculating section 15 includes a tail end position selecting section 151, a forward progress amount estimating section 152, a backup amount estimating section 153, a past tail end position acquiring section 154, a steadiness determining section 155, and a tail end position estimating section 156.

The tail end position selecting section 151 selects, as a suitable tail end position Pₜ′, a position (the estimation tail end position Pₜ′, as an example in the present embodiment) identified by any one of a plurality of techniques (the technique performed by the group determining section 12 and the technique performed by the WAVE CONGESTION determining section 13 in the present embodiment). The tail end position selecting section 151 includes current tail end position acquiring sections 1511 and 1512 and a selecting section 1513.

The current tail end position acquiring sections 1511 and 1512 respectively acquire estimation tail end positions Pₜ′ identified using different techniques. As an example in the present embodiment, the current tail end position acquiring section 1511 acquires the estimation tail end position Pₜ′ identified by the WAVE CONGESTION determining section 13, and the current tail end position acquiring section 1512 acquires the estimation tail end position Pₜ′ identified by the group determining section 12. The current tail end position acquiring sections 1511 and 1512 may each supply the acquired estimation tail end position Pₜ′ to the selecting section 1513.

The selecting section 1513 selects one of the estimation tail end positions Pₜ′ supplied thereto, as the suitable estimation tail end position Pₜ′. For example, the selecting section 1513 may select whichever position, among the two acquired estimation tail end positions Pₜ′, is farther backward in the progression direction.

The forward progress amount estimating section 152 estimates the forward progress amount of the tail end of the traffic congestion caused by the progression of vehicles in the traffic congestion. The forward progress amount may be a value expressed as Δt·Vₚ by the velocity Vp of a vehicle in the traffic congestion and a reference time Δt. In other words, the forward progress amount may be obtained by multiplying the reference time Δt by the velocity Vp. The reference time Δt may be an interval of sampling timings of the vehicle velocity, and may be 1 second, for example. The velocity Vₚ may be the velocity V(t) at the current time point of the IoT vehicle 10A at the tail end of the traffic congestion identified by the tail end position identifying section 123 or the tail end position identifying section 133, or may be a velocity V(t−Δt) at the previous sampling timing. The forward progress amount estimating section 152 may acquire the velocity Vₚ from the group determining section 12 or the WAVE CONGESTION determining section 13. The forward progress amount estimating section 152 may supply the forward progress amount to the tail end position estimating section 156.

The backup amount estimating section 153 estimates a backup amount of the tail end of the traffic congestion caused by vehicles 10 being added to the traffic congestion. The backup amount may be a value expressed as Δt·G/I using an average interval I of the timings at which a plurality of IoT vehicles 10A have passed the same geographical point in a region where traffic congestion does not occur on the road including the tail end of the traffic congestion (e.g., regions before the traffic congestion), the inter-vehicle distance G in this region where traffic congestion does not occur, and the reference time Δt. In other words, the backup amount may be obtained by multiplying the reference time Δt by a result of dividing the inter-vehicle distance G by the average interval I. The same geographical point in the region where traffic congestion does not occur on the road may be the start point of the road, for example. The inter-vehicle distance G may be the maximum distance between IoT vehicles 10A, or may be the average distance between IoT vehicles 10A. The backup amount estimating section 153 may supply the backup amount to the tail end position estimating section 156.

The past tail end position acquiring section 154 acquires a position P_{t-Δt} of the tail end of the traffic congestion at a time point earlier than the current time point by the reference time Δt. The past tail end position acquiring section 154 may acquire the position P_{t-Δt} from the storage section 16, described further below. The past tail end position acquiring section 154 may supply the position P_{t-Δt} to the steadiness determining section 155 and the tail end position estimating section 156.

The steadiness determining section 155 determines whether the tail end of the traffic congestion is holding steady. The steadiness determining section 155 determines whether the distance between the position P_{t-Δt} of the tail end of the traffic congestion and the position of the tail end of the traffic congestion at the current time point (the estimation tail end position Pₜ′ selected by the selecting section 1513, as an example in the present embodiment) is less than a second reference distance. The second reference distance is different from the first reference distance (e.g., 100 m), and may be 2 m, for example. The steadiness determining section 155 may supply the tail end position estimating section 156 with an estimation instruction signal, in response to the determination result being affirmative. In this way, the estimation process by the tail end position estimating section 156 is performed in response to a determination that the distance between the position P_{t-Δt} and the position Pₜ′ is less than a second reference distance. The steadiness determining section 155 may supply the estimation tail end position Pₜ′ selected by the selecting section 1513 to the tail end position estimating section 156, in response to the determination result being negative.

The tail end position estimating section 156 estimates the position Pₜ of the tail end of the traffic congestion at the current time point based on the position P_{t-Δt} of the tail end of the traffic congestion, the forward progress amount Δt−Vₚ, and the backup amount Δt. G/I. The tail end position estimating section 156 may estimate the tail end position Pₜ from the expression Pₜ=P_{t-Δt}+Δt(Vₚ−G/I). The tail end position estimating section 156 may perform the estimation in response to the estimation instruction signal from the steadiness determining section 155. If the estimation instruction signal is not supplied, the tail end position estimating section 156 may set the estimation tail end position Pₜ′ as the tail end position Pₜ. The tail end position estimating section 156 may store the tail end position Pₜ in the storage section 16. Furthermore, the tail end position estimating section 156 may output the tail end position Pₜ to the outside of the apparatus 1.

The storage section 16 consecutively stores the tail end position Pₜ at each time point. The storage section 16 may further store data acquired by the data acquiring section 11, data calculated by the calculating section 1311, and the like.

According to the WAVE CONGESTION determining section 13 of the apparatus 1 described above, an IoT vehicle 10A is determined to be a vehicle in traffic congestion in response to the velocity being less than or equal to a threshold value and the velocity being detected to be in a fluctuating state. Accordingly, even if the nearby vehicles 10 are not IoT vehicles 10A and the travel states thereof cannot be known, it is possible to identify the target IoT vehicle 10A as being a vehicle in traffic congestion. Accordingly, even if the ratio of IoT vehicles 10A to the total vehicles 10 is low, it is possible to accurately identify the position of traffic congestion.

Furthermore, the velocity is determined to be in a fluctuating state in response to the wave trend, which is the moving average of the difference a(t) between the velocity V(t−i) acquired in the past and the newly acquired velocity V(t), being in a first range and the wave dispersion, which is a dispersion index value of the difference a(t), being in a second range. Accordingly, it is possible to reliably detect the fluctuating state of the velocity.

Furthermore, the position of the tail end of traffic congestion is identified based on the position of an IoT vehicle 10A determined to be a vehicle in the traffic congestion, and therefore it is possible to accurately identify the position of the tail end of the traffic congestion.

Yet further, according to the group determining section 12, the position of the tail end of the traffic congestion is identified based on the position of the IoT vehicle 10A at the tail end of each group including vehicles in traffic congestion having more than a reference number of vehicles in which the distance between vehicles is less than a first reference distance (e.g., 100 m) as a congestion group. Accordingly, even if the ratio of IoT vehicles 10A is low, it is possible to accurately identify the position of the tail end of the traffic congestion.

Yet further, according to the tail end position calculating section 15, the position Pₜ of the tail end of the traffic congestion at the current time point is identified based on the position P_{t-Δt}, occurring a reference time Δt earlier, of the tail end of the traffic congestion and the forward progress amount and backup amount that are estimated for the position P_{t-Δt}. Accordingly, even if the ratio of IoT vehicles 10A is low, it is possible to identify the position of the tail end of the traffic congestion.

Yet further, the position Pₜ of the tail end of the traffic congestion at the current time point is estimated if the distance between the position P_{t-Δt}, occurring a reference time Δt earlier, of the tail end of the traffic congestion and the tail end position Pₜ′ at the current time point acquired by the group determining section 12 or the WAVE CONGESTION determining section 13 is greater than a second reference distance (e.g., 2 m). Accordingly, if there is a possibility of erroneously determining that a vehicle is stuck in traffic congestion due to the ratio of IoT vehicles 10A being low, it is possible to estimate the position Pₜ of the tail end of the traffic congestion.

Yet further, according to the tail end position selecting section 151, whichever position is farther backward in the progression direction, among the two estimation tail end positions Pₜ′ acquired using different techniques, is selected as the suitable tail end position. Accordingly, a predicted time for arriving at traffic congestion is estimated to be early, and a predicted time for passing through the traffic congestion is estimated to be longer. Therefore, vehicles that could enter into traffic congestion can be encouraged to consider an alternate route, and it is possible to avoid increasing the length of the traffic congestion.

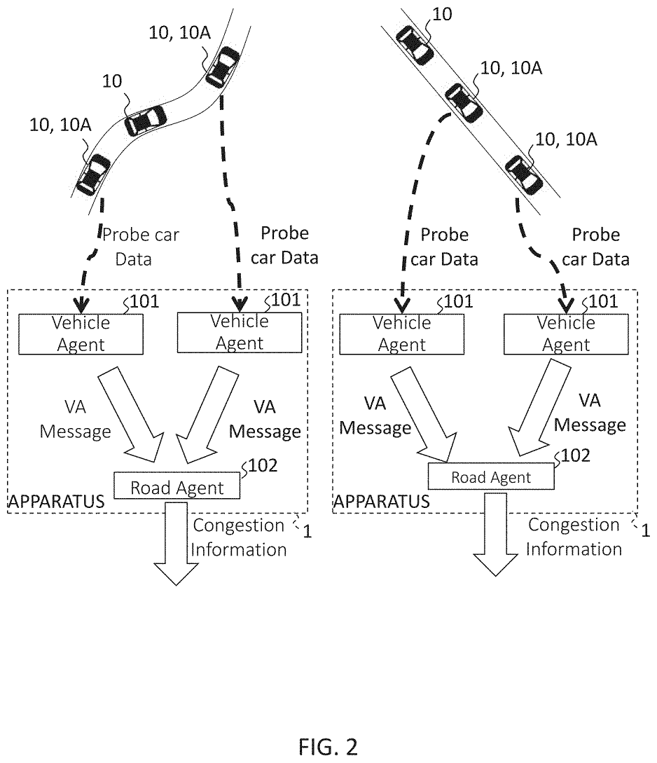

FIG. 2 shows a state in which an apparatus 1 is arranged, according to an embodiment of the present invention. The apparatus 1 may include a plurality of vehicle agents 101 and road agents 102 that function as portions of the configuration shown in FIG. 1. An “agent” may be a software entity having specific data, and may be operable to receive a message (e.g., command) and return a result of the message. The plurality of vehicle agents 101 and road agents 102 may be executed by at least one server. The server may exist at any point on a network including the Internet, a subscriber network, a cellular network, or a desired combination of networks. The servers may be computers or other types of data processors, and may be dedicated servers, or may be shared servers that perform other operations.

The plurality of vehicle agents 101 are provided respectively to the IoT vehicles 10A. As an example in the present embodiment, each vehicle agent 101 may function as the data acquiring section 11, the travel state identifying section 121, the fluctuating state detecting section 131, and the traffic congestion vehicle determining section 132. The vehicle agent 101 may acquire the probe car data from the target IoT vehicle 10A. The vehicle agent 101 transmits to the road agent 102, as a VA message, the position information and velocity information acquired by the data acquiring section 11, the travel state identified by the travel state identifying section 121, and the fluctuating state identified by the fluctuating state determining section 1312.

A road agent 102 is provided to each road. A single road is a path connecting two geographical points, and may be separated according to the speed limit, for example. A road may include an intersection point, but does not need to include the side streets following the branch. The road may include a plurality of lanes. The road agent 102 may function as the group detecting section 122, the tail end position identifying section 123, the tail end position identifying section 133, the trend determining section 14, the tail end position calculating section 15, and the storage section 16. The road agent 102 may transmit the tail end position Pₜ of the traffic congestion to an external apparatus as congestion information.

In the present embodiment, the apparatus 1 is described as including a single road agent 102 and managing traffic congestions on a single road, but the apparatus 1 may include a plurality of road agents 102 and manage traffic congestions on a plurality of roads.

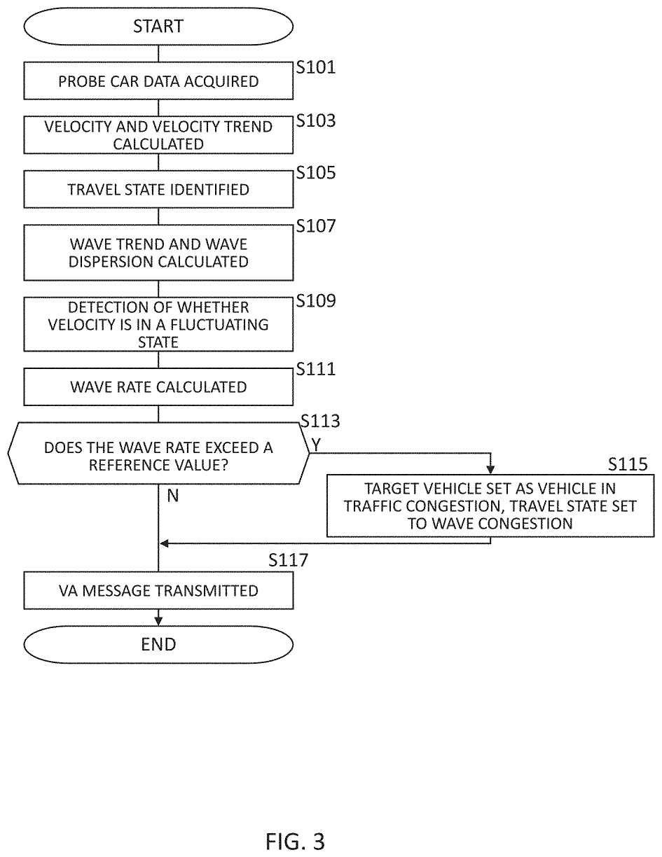

FIG. 3 shows the operation of the vehicle agents 101, according to an embodiment of the present invention. Each vehicle agent 101 generates a VA message relating to the target IoT vehicle 10A by performing the processes of steps S101 to S117, and transmits the VA message to the road agent 102.

At step S101, the data acquiring section 11 acquires the probe car data from the target IoT vehicle 10A. The data acquiring section 11 may acquire the position information of the target IoT vehicle 10A from the probe car data.

At step S103, the data acquiring section 11 calculates the current velocity V(t), the average velocity (e.g., the moving average velocity or decaying average velocity) Vₐᵥₑ(t), and the velocity trend T(t) of the target IoT vehicle 10A, from the current position information and past position information of the target IoT vehicle 10A.

At step S105, the travel state identifying section 121 identifies the travel state of the target IoT vehicle 10A, based on the velocity parameters of this IoT vehicle 10A. For example, the travel state identifying section 121 may set the travel state to be STOP if the average velocity Vₐᵥₑ(t) satisfies Vₐᵥₑ(t)<0.1 (km/h), set the travel state to be CONGESTION if the average velocity Vₐᵥₑ(t) satisfies 0.1≤Vₐᵥₑ(t)<5 (km/h), set the travel state to be SLOW if the average velocity Vₐᵥₑ(t) satisfies 5≤Vₐᵥₑ(t)<V_{LIMIT}/2 (km/h), and set the travel state to be FREE if the average velocity Vₐᵥₑ(t) satisfies V_{LIMIT}/2≤Vₐᵥₑ(t). V_{LIMIT} may be a speed limit on the road. The speed limit V_{LIMIT} may be acquired from outside the apparatus 1, based on the position information of the IoT vehicle 10A included in the probe car data. Instead of this, a correspondence relationship between the position information at each position that can be travelled and the speed limit V_{LIMIT} at each of these positions may be stored in advance in the travel state identifying section 121.

At step S107, the calculating section 1311 calculates the wave trend and the wave dispersion. For example, the calculating section 1311 calculates, as the wave trend, the moving average of the difference a(t) (=V(t)−V(t−1)) between the velocity V(t−1) acquired in the past and a newly acquired velocity V(t). Furthermore, the calculating section 1311 calculates, as the wave dispersion, the dispersion index value (e.g., the average absolute error) of the difference a(t).

At step S109, the fluctuating state determining section 1312 detects whether the velocity is in a fluctuating state, according to whether the wave trend is in the first range and the wave dispersion is in the second range. As an example, the fluctuating state determining section 1312 may determine that the velocity is in the fluctuating state in response to the wave trend being in a range of −0.2 to 0.2 and the wave dispersion being within a range of 0.7 to 3.3.

At step S111, the traffic congestion vehicle determining section 132 calculates the cumulative index value (also referred to as the wave rate) indicating whether the target IoT vehicle 10A is a vehicle in traffic congestion, based on whether the velocity is in the fluctuating state and on the travel state identified in step S105. For example, the traffic congestion vehicle determining section 132 consecutively updates the wave rate by adding, to the previously calculated wave rate, a constant corresponding to whether the velocity is in the fluctuating state and a constant corresponding to the identified travel state. As an example, the traffic congestion vehicle determining section 132 may calculate the wave rate to be 0.2 if the velocity is in the fluctuating state, and calculate the wave rate to be 0 if the velocity is not in the fluctuating state. The traffic congestion vehicle determining section 132 may add −0.005 to the wave rate if the travel state is STOP or CONGESTION, add −0.2 to the wave rate if the travel state is SLOW, and add −1.0 to the wave rate if the travel state is FREE.

At step S113, the traffic congestion vehicle determining section 132 may determine whether the wave rate of the target IoT vehicle 10A exceeds a reference value and the parameter of the velocity parameter of the IoT vehicle 10A is less than or equal to the predetermined first threshold value (e.g., 5 km/h). The reference value may be 1.0, for example. If the determination result is affirmative (step S113: Yes), the traffic congestion vehicle determining section 132 moves the processing to step S115, and if the determination result is negative (step S113: No), the traffic congestion vehicle determining section 132 moves the processing to step S117.

At step S115, the traffic congestion vehicle determining section 132 sets the target IoT vehicle 10A as a vehicle in traffic congestion, and changes the travel state of the target IoT vehicle 10A to WAVE CONGESTION. In this way, the target IoT vehicle 10A is determined to be a vehicle in traffic congestion, in response to the wave rate exceeding the reference value.

At step S117, the vehicle agent 101 transmits the VA message to the road agent 102. The vehicle agent 101 may include in the VA message the position information and velocity information (current velocity V(t), average velocity Vₐᵥₑ(t), and velocity trend T(t)) acquired by the data acquiring section 11, the travel state identified by the travel state identifying section 121, and the determination result concerning whether the vehicle is in traffic congestion by the traffic congestion vehicle determining section 132, and transmit this VA message to the road agent 102. If the travel state of the target IoT vehicle 10A is FREE, the vehicle agent 101 does not need to transmit the VA message.

According to the operation described above, the wave rate is cumulatively calculated based on whether the velocity is in the fluctuating state and on the identified travel state, and the vehicle is determined to be a vehicle in traffic congestion in response to the wave rate exceeding the reference value. Accordingly, the determination of whether a vehicle is a vehicle in traffic congestion takes into consideration the past states, and therefore it is possible to prevent frequent changes in the determination result.

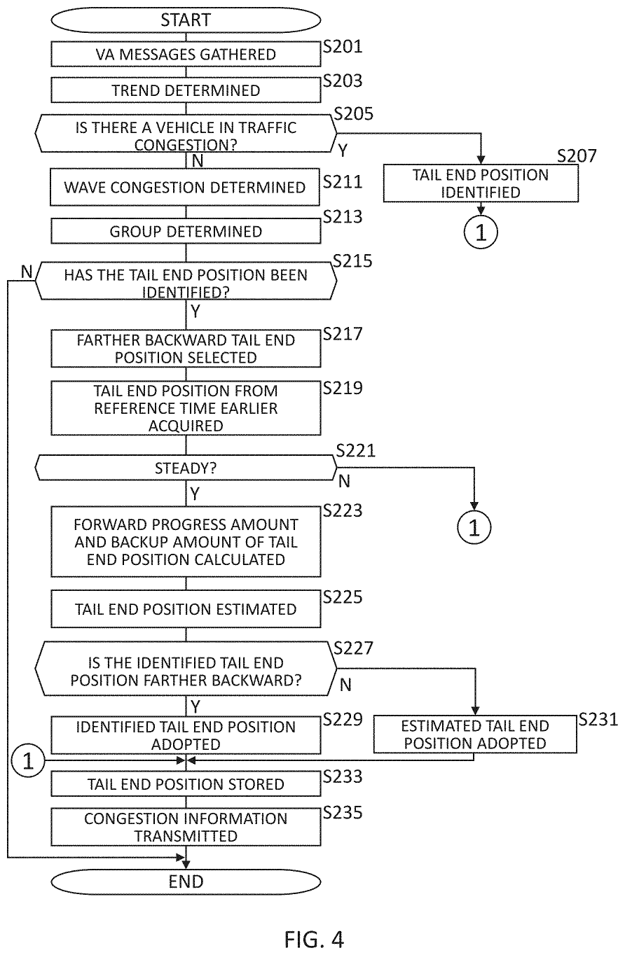

FIG. 4 shows the operation of a road agent 102, according to an embodiment of the present invention. The road agent 102 outputs the tail end position Pₜ of the traffic congestion by performing the processes of steps S201 to S235.

At step S201, the road agent 102 gathers the VA messages from the vehicle agents 101 corresponding to each of the IoT vehicles 10A positioned on the target road. For example, the road agent 102 may gather the VA messages including the position information on the target road.

At step S203, the tail end position identifying section 141 of the trend determining section 14 detects vehicles in traffic congestion, using the current velocity V(t) and velocity trend T(t) (T(t)=(V(t)−V(t−w))/w, as an example in the present embodiment) included in each VA message. For example, for each VA message, the tail end position identifying section 141 may determine whether the velocity trend T(t) is less than the reference velocity trend Tref and the velocity V(t) is less than the second threshold value. The tail end position identifying section 141 may identify a IoT vehicle 10A corresponding to a VA message for which the determination result was affirmative to be a vehicle in traffic congestion. The reference velocity trend Tref may be −2 km, for example. The second threshold value may be V_{LIMIT}/2, as an example in the present embodiment.

At step S205, the tail end position identifying section 141 determines whether there are any vehicles in traffic congestion. If the determination result is affirmative (step S205: Yes), the tail end position identifying section 141 moves the processing to step S207, and if the determination result is negative, the tail end position identifying section 141 moves the processing to step S211.

At step S207, the tail end position identifying section 141 identifies the position Pₜ of the tail end of the traffic congestion. The tail end position identifying section 141 may set the position that is farthest backward in the progression direction, among the positions of each IoT vehicle 10A identified as a vehicle in traffic congestion, as the position Pₜ of the tail end of the traffic congestion. When the processing of step S207 ends, the road agent 102 moves the processing to step S233.

At step S211, the tail end position identifying section 133 of the WAVE CONGESTION determining section 13 identifies the estimation tailed end position Pₜ′ based on the determination result by the traffic congestion vehicle determining section 132 concerning whether a vehicle is in traffic congestion. The tail end position identifying section 133 may identify the estimation tail end position Pₜ′ based on the position of a vehicle 10 (an IoT vehicle 10A whose travel state is identified as being WAVE CONGESTION, as an example in the present embodiment) as being a vehicle in traffic congestion by the traffic congestion vehicle determining section 132. For example, if there are a plurality of vehicles in traffic congestion on the target road, the tail end position identifying section 133 may set the position of the vehicle in the traffic congestion that is farthest backward in the progression direction as the estimation tail end position Pₜ′. It should be noted that this processing of step S211 may be performed after the processing of step S213.

At step S213, the group determining section 12 identifies the estimation tail end position Pₜ′ based on the travel state identified by the travel state identifying section 121.

For example, the group detecting section 122 of the group determining section 12 may sort the VA messages in order from the farthest forward or from the farthest backward in the progression direction of the road and calculate the inter-vehicle distance between the IoT vehicles 10A, based on the position information of each IoT vehicle 10A. The group detecting section 122 sets an IoT vehicle 10 whose travel state is any one of STOP, WAVE CONGESTION, and CONGESTION as a vehicle in traffic congestion. The group detecting section 122 may detect, as a congestion group, at least one group including vehicles in traffic congestion including more than a reference number (e.g., 2) of vehicles in which the distance between vehicles is less than a first reference distance (e.g., 100 m).

Furthermore, the tail end position identifying section 123 of the group determining section 12 identifies the estimation tail end position Pₜ′ based on the position of the IoT vehicle 10A at the tail end of each congestion group. For example, if a plurality of congestion groups are detected, the tail end position identifying section 123 may set the position of the IoT vehicle 10A at the tail end of the congestion group that is farthest backward in the progression direction as the estimation tail end position Pₜ′. Instead, the tail end position identifying section 123 may set the positions of the IoT vehicles 10A at the tail ends of each congestion group as estimation tail end positions Pₜ′.

At step S215, the tail end position calculating section 15 determines whether an estimation tail end position Pₜ′ has been identified. For example, the tail end position calculating section 15 may determine whether an estimation tail end position Pₜ′ identified by the WAVE CONGESTION determining section 13 or the group determining section 12 has been acquired by the current tail end position acquiring section 1511 or 1512. If the determination result is negative (step S215: No), then no traffic congestions exist on the target road, and therefore the road agent 102 may end the processing. If the determination result is affirmative (step S215: Yes), the tail end position calculating section 15 moves the processing to step S217.

At step S217, the selecting section 1513 of the tail end position calculating section 15 selects the position that is farthest backward in the progression direction, from among the estimation tail end positions Pₜ′ identified by the WAVE CONGESTION determining section 13 or the group determining section 12.

At step S219, the past tail end position acquiring section 154 acquires the position P_{t-Δt} of the tail end of the traffic congestion occurring the reference time Δt (e.g., 1 second) before the current time point. The past tail end position acquiring section 154 may acquire the position P_{t-Δt} from the storage section 16.

At step S221, the steadiness determining section 155 determines whether the tail end of the traffic congestion is holding steady. The steadiness determining section 155 determines whether the distance between the position P_{t-Δt}, occurring the reference time Δt earlier, of the tail end of the traffic congestion and the estimation tail end position Pₜ′ at the current time point selected at step S217 is less than a second reference distance (e.g., 2 m). If the determination result is negative (step S221: No), the road agent 102 moves the processing to step S233 and uses the estimation tail end position Pₜ′ as the tail end position Pₜ estimated at the current time point, and if the determination result is affirmative (step S221: Yes), the road agent 102 moves the processing to step S223.

At step S223, the forward progress amount estimating section 152 and the backup amount estimating section 153 calculate the forward progress amount Δt·Vₚ and the backup amount Δt·I/G of the estimated tail end of the traffic congestion.

At step S225, the tail end position estimating section 156 tentatively estimates a provisional position P_{t(PROVISIONAL)} of the tail end of the traffic congestion at the current time point. The tail end position estimating section 156 may estimate the tail end position P_{t(PROVISIONAL)} from the expression Pₜ=P_{t-Δt}+Δt(Vₚ−G/i). In the present embodiment, the position P_{t-Δt}, occurring the reference time Δt earlier, of the tail end of the traffic congestion, the forward progress amount Δt·Vₚ of the tail end of the traffic congestion, and the backup amount Δt·G/I of the tail end of the traffic congestion are all identified by the apparatus 1 for each IoT vehicle 10A using the AV messages, and are therefore based only on the information for the IoT vehicles 10A among the plurality of vehicles 10. Instead, at least one of the position, occurring the reference time Δt earlier, of the tail end of the traffic congestion, the forward progress amount of the tail end of the traffic congestion, and the backup amount of the tail end of the traffic congestion may be based on the information of a vehicle 10 that is not a IoT vehicle 10A.

At step S227, the tail end position estimating section 156 determines whether the estimation tail end position Pₜ′ at the current time point selected at step S217 is farther backward in the progression direction than the position P_{t(PROVISIONAL)} of the tail end of the traffic congestion at the current time point that was tentatively estimated. If the determination result is affirmative (step S227: Yes), the tail end position estimating section 156 moves the processing to step S229, and if the determination result is negative (step S227: No), the tail end position estimating section 156 moves the processing to step S231.

At step S229, the tail end position estimating section 156 adopts the estimation tail end position Pₜ′ selected at step S217 as the position Pₜ of the tail end of the traffic congestion estimated at the current time point.

At step S231, the tail end position estimating section 156 adopts the position P_{t(PROVISIONAL)} of the tail end of the traffic congestion at the current time point that was tentatively estimated at step S225 as the position Pₜ of the tail end of the traffic congestion estimated at the current time point.

At step S233, the storage section 16 stores the tail end position Pₜ of the traffic congestion at the current time point. The stored tail end position Pₜ can be any one of the tail end position Pₜ identified by the trend determining section 14 at step S207, the tail end position Pₜ′ identified by the WAVE CONGESTION determining section 13 at step S211, the tail end position Pₜ′ identified by the group determining section 12 at step S213, and the tail end position Pₜ estimated by the tail end position estimating section 156 at step S225. If the tail end position Pₜ estimated at step S225, i.e., the tail end position P_{t(PROVISIONAL)}, is stored in the storage section 16, this tail end position P_{t(PROVISIONAL)} is acquired as the tail end position P_{t-Δt} in the process of step S219 performed the reference time Δt later.

At step S235, the road agent 102 includes the tail end position Pₜ of the traffic congestion in the congestion information, and transmits this congestion information to the outside of the apparatus 1. The road agent 102 may identify the IoT vehicle 10 at the front of the traffic congestion from the travel states in the VA messages, calculate the traffic congestion length from this position and the tail end position Pₜ, and include this traffic congestion length in the congestion information. If the determination result is negative in step S215 described above (step S215: No), the road agent 102 may transmit information indicating that there is no traffic congestion on the target road to an external apparatus, as the congestion information.

The external apparatus that has received the congestion information concerning the target road from the road agent 102 may notify a vehicle 10 that the tail end position Pₜ of the traffic congestion is located on this target road or on a nearby road. If the traffic congestion length is included in the congestion information, the external apparatus may notify a vehicle 10 about the tail end position Pₜ in response to this traffic congestion length being longer than a reference length (e.g., 100 m). The external apparatus may notify a vehicle 10 about the tail end position Pₜ in response to the tail end position Pₜ being steady for longer than a reference time (e.g., the signal cycle of a traffic light).

According to the operation described above, if the estimation tail end position Pₜ′ selected at step S217 is farther backward in the progression direction than the tail end position P_{t(PROVISIONAL)} tentatively estimated at step S225, the estimation tail end position Pₜ′ is adopted as the tail end position Pₜ estimated at the current time point. Accordingly, if the tentatively estimated position P_{t(PROVISIONAL)} of the tail end of the traffic congestion is inaccurate, the estimated position Pₜ of the tail end of the traffic congestion can be suitably positioned.

Furthermore, since the tail end position P_{t(PROVISIONAL)} estimated by the tail end position estimating section 156 is acquired as the tail end position P_{t-Δt} that is the reference time earlier and then used in the next estimation, even if the position Pₜ of the tail end of the traffic congestion cannot be acquired, the estimation of the tail end position can continue.

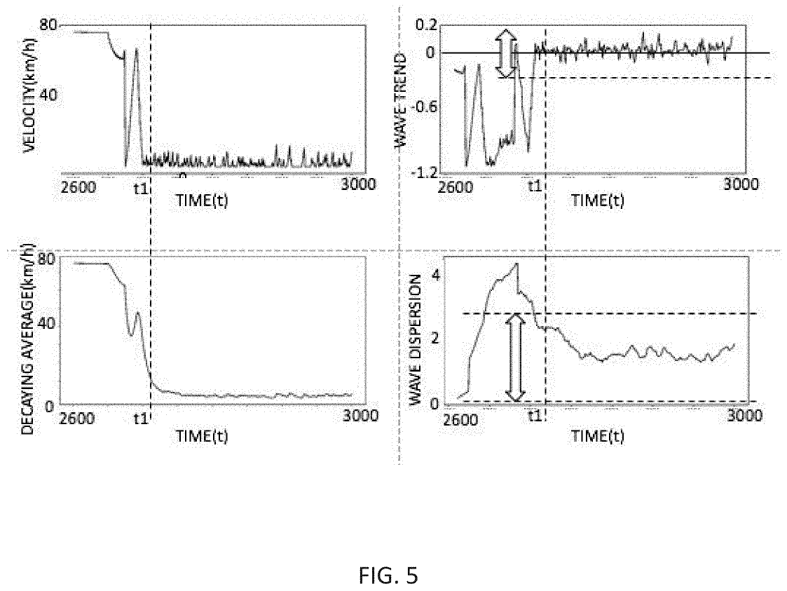

FIG. 5 shows a specific example of the fluctuating state of the velocity, according to an embodiment of the present invention. In the drawing, the upper left and lower left graphs show the velocity V(t) and the decaying average Vₐᵥₑ(t) thereof. In these graphs, the horizontal axes indicate time (seconds) and the vertical axes indicate velocity (km/h). The upper right graph shows the wave trend, in which the vertical axis indicates the wave trend value (km/m) and the horizontal axis indicates time (seconds). The lower right graph shows the wave dispersion, in which the vertical axis indicates the wave dispersion value (km/m) and the horizontal axis indicates time (seconds).

In this example, a vehicle 10 enters a traffic congestion from the time point t1. Due to this, the wave trend is included in the first range of −0.2 to 0.2 (see the arrow symbol in the upper right portion of the drawing) and the wave dispersion is included in the second range of 0.7 to 3.3 (see the arrow symbol in the lower right portion of the drawing), and therefore the velocity is determined to be in a fluctuating state.

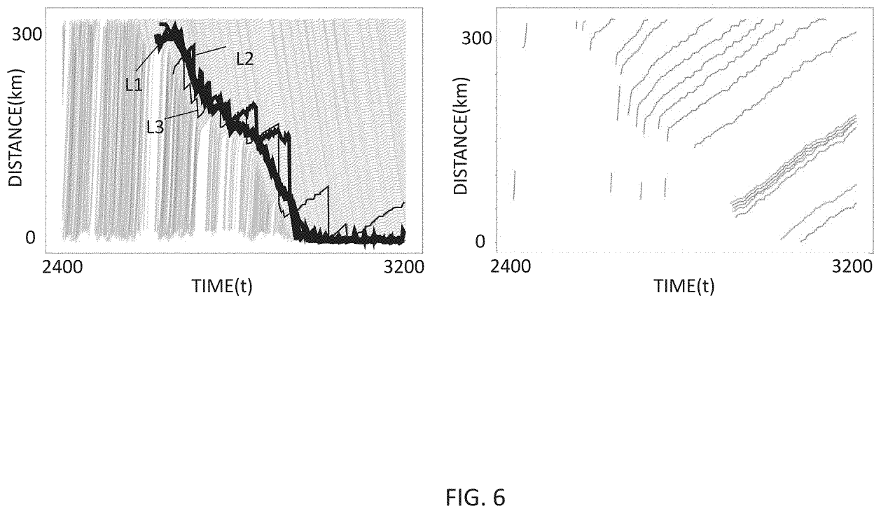

FIG. 6 shows a transition of the positions of the vehicles 10 that have moved onto a road, according to an embodiment of the present invention. In the drawing, the vertical axis indicates the distance (m) from the start point of the road (the end on the backward side in the progression direction) to the vehicle 10, and the horizontal axis indicates time (seconds). Each thin line in the graph on the left side of the drawing indicates a transition of the positions of all vehicles 10 that have moved onto the road. Each thin line in the graph on the right side of the drawing indicates a transition of the positions of all IoT vehicles 10A that have moved onto the road. In this example, the ratio of IoT vehicles 10A among all vehicles is 5%.

The thick line L1 indicates the tail end position of traffic congestion detected based on the transition of positions of all of the vehicles 10. The thick line L2 indicates the tail end position Pₜ of the traffic congestion identified or estimated by the apparatus 1 based on the transition of the positions indicated by the probe car data of the IoT vehicles 10A that have moved onto the road. The thick line L3 indicates the tail end position Pₜ of the traffic congestion identified by only comparison between threshold values with the velocity trend T(t) and the velocity, which is not the average velocity, based on the transition of the position indicated by the probe car data of the IoT vehicles 10A that have moved onto the road. As shown in this drawing, according to the apparatus 1, even if the ratio of IoT vehicles 10A is low, the tail end position Pₜ of the traffic congestion is identified more accurately than in a case where only the trend determining section 14 is used.

In the embodiments described above, one vehicle agent 101 is described as being provided for one IoT vehicle 10A. However, as long as a vehicle agent 101 processes the probe car data for each IoT vehicle 10A, one vehicle agent 101 may be provided for a plurality of IoT vehicles 10A. Furthermore, one road agent 102 is described as being provided for one road. However, as long as a road agent 102 processes the VA messages for each road, one road agent 102 may be provided for a plurality of roads.

Furthermore, the apparatus 1 is described as including the data acquiring section 11, the group determining section 12, the WAVE CONGESTION determining section 13, the trend determining section 14, the tail end position calculating section 15, and the storage section 16. However, at least one component other than the WAVE CONGESTION determining section 13 may be omitted from the apparatus 1, or at least one component other than the tail end position calculating section 15 may be omitted from the apparatus 1. If the apparatus 1 does not include the group determining section 12, the WAVE CONGESTION determining section 13 may include the travel state identifying section 121. If the apparatus 1 does not include the tail end position calculating section 15, at least one of the group determining section 12 and the WAVE CONGESTION determining section 13 may output the identified tail end position Pₜ′ to the outside of the apparatus 1 as the tail end position Pₜ.

Yet further, the tail end position calculating section 15 is described as including the forward progress amount estimating section 152, the backup amount estimating section 153, the past tail end position acquiring section 154, the steadiness determining section 155, and the tail end position estimating section 156. However, at least one of these components may be omitted from the tail end position calculating section 15. In this case, the tail end position selecting section 151 may output the selected tail end position Pₜ′ to the outside of the apparatus 1 as the tail end position Pₜ.

Yet further, the probe car data is described as including position information of the IoT vehicle 10A, but may further include a vehicle ID of this IoT vehicle 10A, an ID of the road being travelled, the speed limit V_{LIMIT} of this road, the travel velocity V(t), the distance from the start point of the road, and the like. If the probe car data includes a road ID, the road agent 102 may gather the probe car data that includes a road ID corresponding to the target road. If the probe car data includes the travel velocity V(t), the data acquiring section 11 does not need to calculate the travel velocity V(t).

Yet further, the travel state identifying section 121 is described as identifying the travel state of an IoT vehicle 10A and supplying this travel state to the group detecting section 122. However, the travel state identifying section 121 may identify whether the IoT vehicle 10A is a vehicle in traffic congestion, and supply this information to the group detecting section 122. For example, the travel state identifying section 121 may identify the IoT vehicle 10A as being a vehicle in traffic congestion if Vₐᵥₑ(t)<5 (km/h).

Various embodiments of the present invention may be described with reference to flowcharts and block diagrams whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable media, and/or processors supplied with computer-readable instructions stored on computer-readable media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

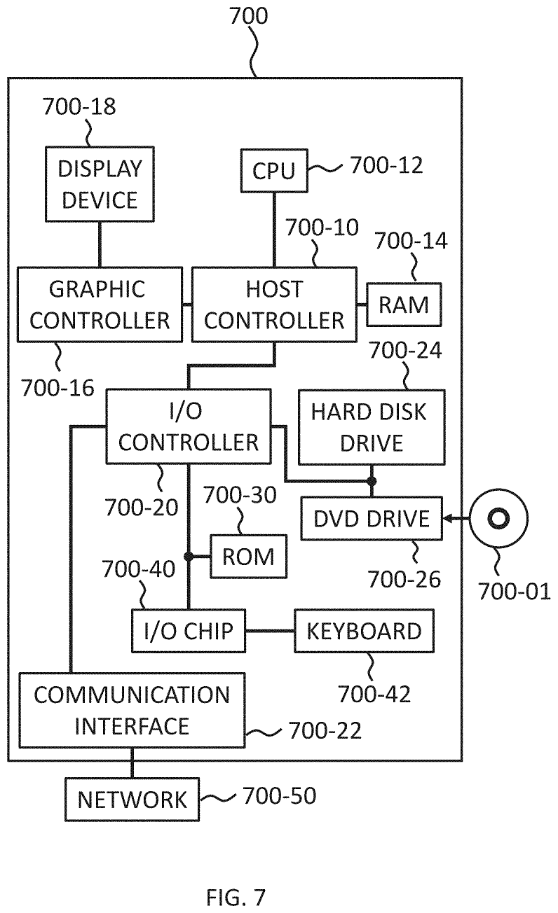

FIG. 7 shows an example of a computer 700 in which aspects of the present invention may be wholly or partly embodied, according to an embodiment of the present invention. A program that is installed in the computer 700 can cause the computer 700 to function as or perform operations associated with apparatuses of the embodiments of the present invention or one or more sections thereof, and/or cause the computer 700 to perform processes of the embodiments of the present invention or steps thereof. Such a program may be executed by the CPU 700-12 to cause the computer 700 to perform certain operations associated with some or all of the blocks of flowcharts and block diagrams described herein.

The computer 700 according to the present embodiment includes a CPU 700-12, a RAM 700-14, a graphics controller 700-16, and a display device 700-18, which are mutually connected by a host controller 700-10. The computer 700 also includes input/output units such as a communication interface 700-22, a hard disk drive 700-24, a DVD-ROM drive 700-26 and an IC card drive, which are connected to the host controller 700-10 via an input/output controller 700-20. The computer also includes legacy input/output units such as a ROM 700-30 and a keyboard 700-42, which are connected to the input/output controller 700-20 through an input/output chip 700-40.

The CPU 700-12 operates according to programs stored in the ROM 700-30 and the RAM 700-14, thereby controlling each unit. The graphics controller 700-16 obtains image data generated by the CPU 700-12 on a frame buffer or the like provided in the RAM 700-14 or in itself, and causes the image data to be displayed on the display device 700-18.

The communication interface 700-22 communicates with other electronic devices via a network 700-50. The hard disk drive 700-24 stores programs and data used by the CPU 700-12 within the computer 700. The DVD-ROM drive 700-26 reads the programs or the data from the DVD-ROM 700-01, and provides the hard disk drive 700-24 with the programs or the data via the RAM 700-14. The IC card drive reads programs and data from an IC card, and/or writes programs and data into the IC card.

The ROM 700-30 stores therein a boot program or the like executed by the computer 700 at the time of activation, and/or a program depending on the hardware of the computer 700. The input/output chip 700-40 may also connect various input/output units via a parallel port, a serial port, a keyboard port, a mouse port, and the like to the input/output controller 700-20.

A program is provided by computer readable media such as the DVD-ROM 700-01 or the IC card. The program is read from the computer readable media, installed into the hard disk drive 700-24, RAM 700-14, or ROM 700-30, which are also examples of computer readable media, and executed by the CPU 700-12. The information processing described in these programs is read into the computer 700, resulting in cooperation between a program and the above-mentioned various types of hardware resources. An apparatus or method may be constituted by realizing the operation or processing of information in accordance with the usage of the computer 700.

For example, when communication is performed between the computer 700 and an external device, the CPU 700-12 may execute a communication program loaded onto the RAM 700-14 to instruct communication processing to the communication interface 700-22, based on the processing described in the communication program. The communication interface 700-22, under control of the CPU 700-12, reads transmission data stored on a transmission buffering region provided in a recording medium such as the RAM 700-14, the hard disk drive 700-24, the DVD-ROM 700-01, or the IC card, and transmits the read transmission data to a network or writes reception data received from a network to a reception buffering region or the like provided on the recording medium.

In addition, the CPU 700-12 may cause all or a necessary portion of a file or a database to be read into the RAM 700-14, the file or the database having been stored in an external recording medium such as the hard disk drive 700-24, the DVD-ROM drive 700-26 (DVD-ROM 700-01), the IC card, etc., and perform various types of processing on the data on the RAM 700-14. The CPU 700-12 may then write back the processed data to the external recording medium.

Various types of information, such as various types of programs, data, tables, and databases, may be stored in the recording medium to undergo information processing. The CPU 700-12 may perform various types of processing on the data read from the RAM 700-14, which includes various types of operations, processing of information, condition judging, conditional branch, unconditional branch, search/replace of information, etc., as described throughout this disclosure and designated by an instruction sequence of programs, and writes the result back to the RAM 700-14. In addition, the CPU 700-12 may search for information in a file, a database, etc., in the recording medium. For example, when a plurality of entries, each having an attribute value of a first attribute associated with an attribute value of a second attribute, are stored in the recording medium, the CPU 700-12 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer readable media on or near the computer 700. In addition, a recording medium such as a hard disk or a RAM provided in a server system connected to a dedicated communication network or the Internet can be used as the computer readable media, thereby providing the program to the computer 700 via the network 700-50.

While the embodiments of the present invention have been described, the technical scope of the invention is not limited to the above described embodiments. It will be apparent to persons skilled in the art that various alterations and improvements can be added to the above-described embodiments. It should also apparent from the scope of the claims that the embodiments added with such alterations or improvements are within the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A computer-implemented method comprising:
acquiring a velocity of a vehicle;
detecting whether the velocity is in a fluctuating state; and
determining that the vehicle is in a traffic congestion, in response to a parameter of the velocity being less than or equal to a predetermined threshold value and the velocity being detected to be in the fluctuating state.

2. The computer-implemented method according to claim 1, further comprising:
acquiring a position of the vehicle; and
identifying a position of a tail end of the traffic congestion, based on the position of the vehicle determined to be in the traffic congestion.

3. The computer-implemented method according to claim 1, wherein detecting whether the velocity is in the fluctuating state includes:
calculating a moving average of a difference between a first velocity acquired in the past and a second velocity that is newly acquired, as well as an index value indicating dispersion of the difference; and
determining that the velocity is in the fluctuating state in response to the moving average being in a first range and the index value being in a second range.

4. The computer-implemented method according to claim 1, further comprising:
identifying a travel state of the vehicle based on the parameter, wherein determining that the vehicle is in the traffic congestion includes:
calculating a cumulative index value indicating whether the vehicle is in the traffic congestion, based on whether the velocity is in the fluctuating state and on the identified travel state; and
determining that the vehicle is in the traffic congestion in response to the cumulative index value exceeding a reference value.

5. A computer-implemented method comprising:
acquiring a position of a tail end of a traffic congestion, occurring a reference time earlier;
estimating a forward progress amount of the tail end of the traffic congestion caused by a first set of vehicles in the traffic congestion progressing;
estimating a backup amount of the tail end of the traffic congestion caused by a second set of vehicles being added to the traffic congestion; and
estimating the position of the tail end of the traffic congestion at a current time point, based on the position of the tail end of the traffic congestion, occurring the reference time earlier, the forward progress amount, and the backup amount.

6. The computer-implemented method according to claim 5, further comprising:
acquiring the position of the tail end of the traffic congestion at the current time point; and
determining whether a distance between the position of the tail end of the traffic congestion, occurring the reference time earlier, and the acquired position of the tail end of the traffic congestion at the current time point is less than a reference distance, wherein the estimating the position of the tail end of the traffic congestion at the current time point is performed in response to the distance being less than the reference distance.

7. The computer-implemented method according to claim 5, further comprising:
if the acquired position of the tail end of the traffic congestion at the current time point is farther backward in a progression direction than the estimated position of the tail end of the traffic congestion at the current time point, setting the acquired position of the tail end of the traffic congestion at the current time point as the position of the tail end of the traffic congestion at the current time point.

8. The computer-implemented method according to claim 5, wherein
at least one of the acquiring the position of the tail end of the traffic congestion, occurring the reference time earlier, the estimating the forward progress amount, and the estimating the backup amount is performed based on information for only a portion of vehicles amongst a plurality of vehicles on a road.

9. The computer-implemented method according to claim 5, wherein
the forward progress amount is a value obtained by multiplying the reference time by the velocity of a vehicle in the traffic congestion.

10. The computer-implemented method according to claim 5, wherein
the backup amount is a value obtained by multiplying the reference time by a result of dividing a distance between a third set of vehicles in a region where a traffic congestion does not occur on a road including the tail end of the traffic congestion by an average interval between timings at which a plurality of vehicles pass the same geographical point in the region where a traffic congestion does not occur.

11. The computer-implemented method according to claim 5, wherein
acquiring the position of the tail end of the traffic congestion, occurring the reference time earlier, includes acquiring a position estimated as the position of the tail end of the traffic congestion at the current time point in the past, as the position of the tail end of the traffic congestion, occurring the reference time earlier.

12. A computer program product including one or more computer readable storage mediums collectively storing program instructions that are executable by a processor or programmable circuitry to cause the processor or the programmable circuitry to perform operations comprising:
acquiring a velocity of a vehicle;
detecting whether the velocity is in a fluctuating state; and
determining that the vehicle is in a traffic congestion, in response to a parameter of the velocity being less than or equal to a predetermined threshold value and the velocity being detected to be in the fluctuating state.

13. The computer program product according to claim 12, further comprising:
acquiring a position of the vehicle; and
identifying a position of a tail end of the traffic congestion, based on the position of the vehicle determined to be in the traffic congestion.

14. The computer program product according to claim 12, wherein detecting whether the velocity is in the fluctuating state includes:
calculating a moving average of a difference between a first velocity acquired in the past and a second velocity that is newly acquired, as well as an index value indicating dispersion of the difference; and
determining that the velocity is in the fluctuating state in response to the moving average being in a first range and the index value being in a second range.

15. The computer program product according to claim 12, further comprising:
identifying a travel state of the vehicle based on the parameter, wherein determining that the vehicle is in the traffic congestion includes:
calculating a cumulative index value indicating whether the vehicle is in the traffic congestion, based on whether the velocity is in the fluctuating state and on the identified travel state; and
determining that the vehicle is in the traffic congestion in response to the cumulative index value exceeding a reference value.

16. A computer program product including one or more computer readable storage mediums collectively storing program instructions that are executable by a processor or programmable circuitry to cause the processor or the programmable circuitry to perform operations comprising:
acquiring a position of a tail end of a traffic congestion, occurring a reference time earlier;
estimating a forward progress amount of the tail end of the traffic congestion caused by a first set of vehicles in the traffic congestion progressing;
estimating a backup amount of the tail end of the traffic congestion caused by a second set of vehicles being added to the traffic congestion; and
estimating the position of the tail end of the traffic congestion at a current time point, based on the position of the tail end of the traffic congestion, occurring the reference time earlier, the forward progress amount, and the backup amount.

17. The computer program product according to claim 16, further comprising:
acquiring the position of the tail end of the traffic congestion at the current time point; and
determining whether a distance between the position of the tail end of the traffic congestion, occurring the reference time earlier, and the acquired position of the tail end of the traffic congestion at the current time point is less than a reference distance, wherein the estimating the position of the tail end of the traffic congestion at the current time point is performed in response to the distance being less than the reference distance.

18. The computer program product according to claim 16, further comprising:
if the acquired position of the tail end of the traffic congestion at the current time point is farther backward in a progression direction than the estimated position of the tail end of the traffic congestion at the current time point, setting the acquired position of the tail end of the traffic congestion at the current time point as the position of the tail end of the traffic congestion at the current time point.

19. The computer program product according to claim 16, wherein
at least one of the acquiring the position of the tail end of the traffic congestion, occurring the reference time earlier, the estimating the forward progress amount, and the estimating the backup amount is performed based on information for only a portion of vehicles amongst a plurality of vehicles on a road.

20. The computer program product according to claim 16, wherein
the forward progress amount is a value obtained by multiplying the reference time by the velocity of a vehicle in the traffic congestion.

21. The computer program product according to claim 16, wherein
the backup amount is a value obtained by multiplying the reference time by a result of dividing a distance between a third set of vehicles in a region where a traffic congestion does not occur on a road including the tail end of the traffic congestion by an average interval between timings at which a plurality of vehicles pass the same geographical point in the region where a traffic congestion does not occur.

22. The computer program product according to claim 16, wherein
acquiring the position of the tail end of the traffic congestion, occurring the reference time earlier, includes acquiring a position estimated as the position of the tail end of the traffic congestion at the current time point in the past, as the position of the tail end of the traffic congestion, occurring the reference time earlier.

23. An apparatus comprising:
a processor or programmable circuitry; and
one or more computer readable mediums collectively including instructions that, in response to being executed by the processor or the programmable circuitry, cause the processor or the programmable circuitry to:
acquire a velocity of a vehicle;
detect whether the velocity is in a fluctuating state; and
determine that the vehicle is in a traffic congestion, in response to a parameter of the velocity being less than or equal to a predetermined threshold value and the velocity being detected to be in the fluctuating state.

24. The apparatus according to claim 23, the instructions further causing the processor or programmable circuitry to:
acquire a position of the vehicle; and
identify a position of a tail end of the traffic congestion, based on the position of the vehicle determined to be in the traffic congestion.

25. The apparatus according to claim 23, wherein the instructions that cause the processor or programmable circuitry to detect whether the velocity is in the fluctuating state, further includes instructions that cause the processor or programmable circuitry to:
calculate a moving average of a difference between a first velocity acquired in the past and a second velocity that is newly acquired, as well as an index value indicating dispersion of the difference; and
determine that the velocity is in the fluctuating state in response to the moving average being in a first range and the index value being in a second range.
